(19) United States
(12) Patent Application Publication
(10) Pub. No.: US 2022/0255120 A1
(43) Pub. Date: Aug. 11, 2022

(54) NON-AQUEOUS ELECTROLYTE FOR A LITHIUM ION BATTERY AND LITHIUM ION BATTERY COMPRISING THE ELECTROLYTE

(71) Applicant: SHENZHEN CAPCHEM TECHNOLOGY CO., LTD., Shenzhen, Guangdong (CN)

(72) Inventors: Yonghong Deng, Shenzhen, Guangdong (CN); Yuanyuan Kang, Shenzhen, Guangdong (CN); Yunxian Qian, Shenzhen, Guangdong (CN); Shiguang Hu, Shenzhen, Guangdong (CN); Hao Zhang, Shenzhen, Guangdong (CN)

(21) Appl. No.: 17/628,217

(22) PCT Filed: Jul. 30, 2020
(86) PCT No.: PCT/CN2020/105829

§ 371 Date: Jan. 18, 2022

(30) Foreign Application Priority Data
Jul. 31, 2019 (CN) 201910698670.8

(51) Int. Cl. H01M 10/0525; H01M 10/0568; H01M 10/0569; H01M 10/0567

(52) U.S. Cl. CPC H01M 10/0525; H01M 10/0568; C07F 9/062; H01M 10/0567; H01M 2300/0037; H01M 10/0569

(57) ABSTRACT

The application provides a non-aqueous electrolyte for a lithium ion battery, including a non-aqueous organic solvent and lithium salt, and the non-aqueous electrolyte further includes one or more selected from the compounds represented by Formula 1 and Formula 2. R₁, R₂, R₃ and R₄ are each independently selected from a substituted or unsubstituted alkyl group and ether group and unsaturated hydrocarbon group, and at least one of R₁, R₂, R₃ and R₄ is the substituted or unsubstituted unsaturated hydrocarbon group, and R₅ is selected from a substituted or unsubstituted alkylene group and ether group; R₆, R₇ and R₈ are each independently selected from a substituted or unsubstituted alkyl group and ether group and unsaturated hydrocarbon group, provided that at least one of R₆, R₇ and R₈ is the substituted or unsubstituted unsaturated hydrocarbon group. The application also provides a lithium ion battery including the non-aqueous electrolyte.

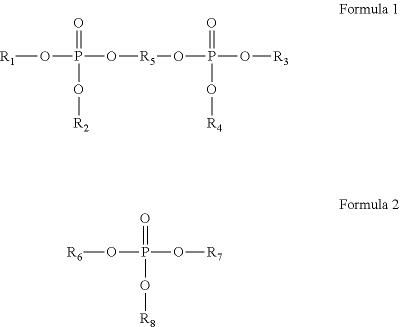

### TECHNICAL FIELD

The application relates to the technical field of lithium ion batteries, in particular to a non-aqueous electrolyte for a lithium ion battery and a lithium ion battery comprising the electrolyte.

### BACKGROUND

Lithium-ion battery has made great progress in the field of portable electronic products because of its high working voltage, high safety, long life and no memory effect. With the development of new energy vehicles, lithium-ion batteries have great application prospects in the power supply system of new energy vehicles.

As one of the most important components of lithium-ion batteries, electrolyte plays a vital role in improving the energy density and cycle stability of lithium-ion batteries. During the charge and discharge process of lithium ion battery, with the reversible intercalation/deintercalation reaction of Li⁺, a series of reactions would occur between electrolyte and electrode materials, forming a solid electrolyte interface film (SEI film) covering the surface of electrode materials. As an electronic insulator and lithium ion conductor, a stable SEI film can prevent further contact between electrolyte and electrode materials, which plays a positive role in the electrochemical performance and safety performance of lithium ion batteries. On the contrary, an unstable SEI film would lead to continuous consumption and reaction of lithium ions, thus generating a series of irreversible by-products, which would result in battery expansion, internal resistance increase, and even fire or explosion, causing great hidden dangers to battery safety. Therefore, the stability of SEI film determines the performance of lithium ion battery.

Many researchers choose different film-forming additives (such as vinylene carbonate, difluoroethylene carbonate, vinylethylene carbonate) to improve the stability of SEI film of lithium-ion battery, for the purpose to improve the performance of the battery. Compared with organic solvents and lithium salts, the required amount of additives is less, the effect is significant, and the cost is lower. Therefore, the development of additives has become the core technology of electrolyte. D. Aurbach et al. studied the additive vinylene carbonate (VC) with electrochemical and spectroscopic methods, and found that VC can improve the cycle performance of the battery, especially at high temperature, and reduce the irreversible capacity. The main reason is that VC can polymerize on graphite surface to form a polyalkyl lithium carbonate film, thus inhibiting the reduction of solvents and salt anions. G. H. Wrodnigg et al. added 5% (volume fraction) ethylene sulfite (ES) or propylene sulfite (PS) to 1 mol/L LiClO₄/propylene carbonate (PC), which can effectively prevent PC molecules from being embedded into graphite electrode and improve the low-temperature performance of the electrolyte. The reason may be that, for example, the reduction potential of ES is about 2V (relative to Li/Li⁺), which is prior to solvent reduction, and SEI film is formed on the surface of graphite negative electrode. Although the research shows that functional additives play a very important role in improving the performance of lithium ion batteries, and the addition of additives can make up for some shortcomings of the electrolyte itself, so far, the research work in this field is not mature enough. For example, there are few reports on additives to improve the working temperature range of lithium ion batteries, especially the types of additives used in high temperature are very limited.

### SUMMARY

The purpose of the present application is to provide a non-aqueous electrolyte for lithium ion batteries, which can give consideration to both high-temperature storage performance and cycle performance of batteries, and further provide a lithium ion battery including the non-aqueous electrolyte.

In order to achieve the above object, the present application adopts the following technical solutions:

According to a first aspect of the present application, the present application provides a non-aqueous electrolyte for a lithium ion battery, including a non-aqueous organic solvent and a lithium salt, the non-aqueous electrolyte further includes one or more selected from the group consisting of compounds represented by Formula 1 and compounds represented by Formula 2:

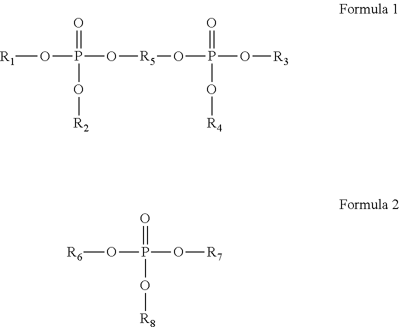

in Formula 1, R₁, R₂, R₃ and R₄ are each independently selected from a substituted or unsubstituted alkyl group of 1-5 carbon atoms, a substituted or unsubstituted ether group of 1-5 carbon atoms and a substituted or unsubstituted unsaturated hydrocarbon group of 2-5 carbon atoms, provided that at least one of R₁, R₂, R₃ and R₄ is the substituted or unsubstituted unsaturated hydrocarbon group of 2-5 carbon atoms, and R₅ is selected from a substituted or unsubstituted alkylene group of 1-5 carbon atoms and a substituted or unsubstituted ether group of 1-5 carbon atoms;

in Formula 2, R₆, R₇ and R₈ are each independently selected from a substituted or unsubstituted alkyl group of 1-5 carbon atoms, a substituted or unsubstituted ether group of 1-5 carbon atoms and a substituted or unsubstituted unsaturated hydrocarbon group of 2-5 carbon atoms, provided that at least one of R₆, R₇ and R₈ is the substituted or unsubstituted unsaturated hydrocarbon group of 2-5 carbon atoms.

As a preferred solution of the present application, the alkyl group of 1-5 carbon atoms may be selected from, for example, methyl, ethyl, n-propyl, isopropyl, n-butyl, isobutyl, sec-butyl, tert-butyl, n-pentyl, isopentyl, sec-pentyl and neopentyl.

As a preferred solution of the present application, the unsaturated hydrocarbon group of 2-5 carbon atoms may be selected from vinyl, propenyl, allyl, butenyl, pentenyl, methyl vinyl, methyl allyl, ethynyl, propinyl, propargyl, butynyl and pentynyl.

As a preferred solution of the present application, the alkylene group of 1-5 carbon atoms is selected from methylene, ethylidene, n-propylene, isopropylidene, n-butylene, isobutylidene, sec-butylidene, tertiary butyl, pentylene, isoamylidene, sec-pentylene and neopentylidene.

As a preferred solution of the present application, the ether group of 1-5 carbon atoms is selected from a methyl ether, diethyl ether, methyl ethyl ether, propyl ether, methyl propyl ether and ethyl propyl ether.

As a preferred solution of the present application, the “substituted” is that one or more hydrogen elements are substituted by halogen; preferably, the halogen is fluorine, chlorine, bromine and iodine; more preferably, the halogen is fluorine.

As a specific preferred solution of the present application, the halogen-substituted alkyl group of 1-5 carbon atoms is a fluoroalkyl group of 1-5 carbon atoms obtained by replacing one or more hydrogen elements in the alkyl group of 1-5 carbon atoms with a fluorine element.

As a specific preferred solution of the present application, the halogen-substituted unsaturated hydrocarbon group of 2-5 carbon atoms is a fluorinated unsaturated hydrocarbon group of 1-5 carbon atoms obtained by replacing one or more hydrogen elements in the unsaturated hydrocarbon group of 2-5 carbon atoms with a fluorine element.

As a specific preferred solution of the present application, the halogen-substituted alkylene group of 1-5 carbon atoms is a fluoroalkylene group of 1-5 carbon atoms obtained by replacing one or more hydrogen elements in the alkylene group of 1-5 carbon atoms with a fluorine element.

As a specific preferred solution of the present application, the halogen-substituted ether group of 1-5 carbon atoms is a fluoroether group of 1-5 carbon atoms obtained by replacing one or more hydrogen elements in the ether group of 1-5 carbon atoms with a fluorine element.

As a more specific preferred solution of the present application, the fluoroether group of 1-5 carbon atoms may be selected from, for example, fluoromethyl ether, fluoroethyl ether, fluoromethyl ethyl ether, fluoropropyl ether, fluoropropyl methyl ether and fluoropropyl ethyl ether.

As a further preferred solution of the present application, the compounds represented by Formula 1 are compounds 1-22 listed in Table 1 below.

TABLE 1
Representative preferred compounds 1-22 of the compounds represented by Formula 1
of the present application

| | |
|---|---|
| 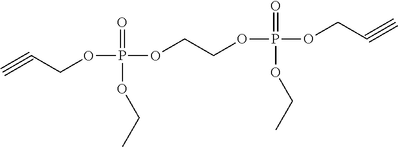 [SMILES: C#CCOP(=O)(OCC)OCCOP(=O)(OCC)OCC#C] | Compound 1 |
| 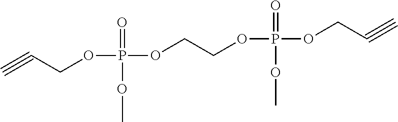 [SMILES: C#CCOP(=O)(OC)OCCOP(=O)(OC)OCC#C] | Compound 2 |
| 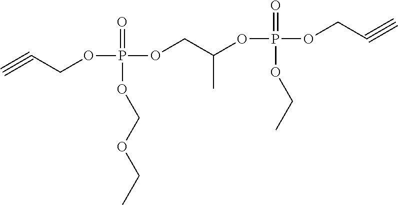 [SMILES: C#CCOP(=O)(OCOCC)OCC(C)OP(=O)(OCC)OCC#C] | Compound 3 |
| 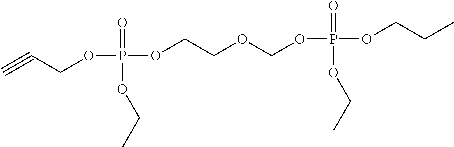 [SMILES: C#CCOP(=O)(OCC)OCCOCOP(=O)(OCC)OCCC] | Compound 4 |
| 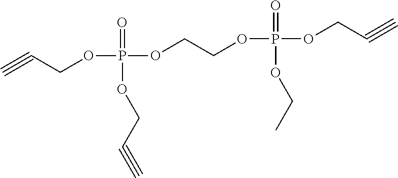 [SMILES: C#CCOP(=O)(OCC)OCCOP(=O)(OCC#C)OCC#C] | Compound 5 |
| 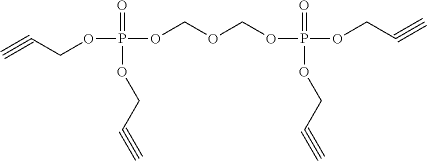 [SMILES: C#CCOP(=O)(OCC#C)OCOCOP(=O)(OCC#C)OCC#C] | Compound 6 |
| 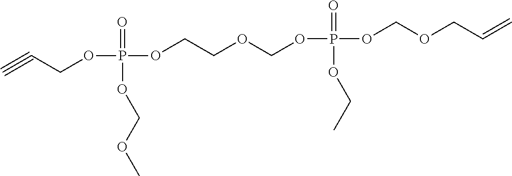 [SMILES: C#CCOP(=O)(OCCOCOP(=O)(OCC)OCOCC=C)OCOC] | Compound 7 |
| 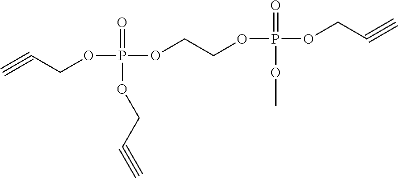 [SMILES: C#CCOP(=O)(OC)OCCOP(=O)(OCC#C)OCC#C] | Compound 8 |
| 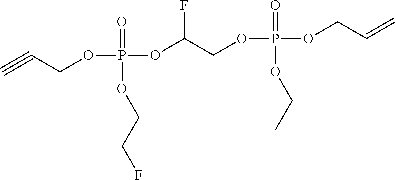 [SMILES: C#CCOP(=O)(OCCF)OC(F)COP(=O)(OCC)OCC=C] | Compound 9 |
| 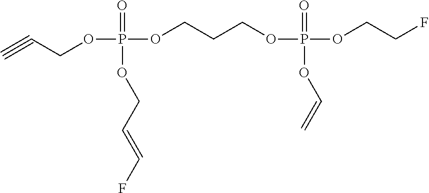 [SMILES: C#CCOP(=O)(OC/C=C/F)OCCCOP(=O)(OC=C)OCCF] | Compound 10 |
| 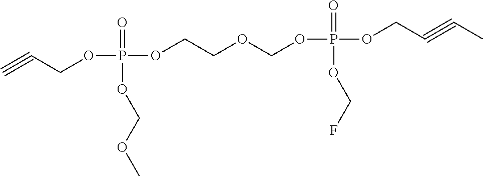 [SMILES: C#CCOP(=O)(OCCOCOP(=O)(OCF)OCC#CC)OCOC] | Compound 11 |
| 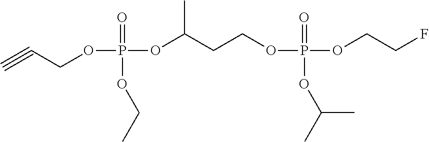 [SMILES: C#CCOP(=O)(OCC)OC(C)CCOP(=O)(OCCF)OC(C)C] | Compound 12 |
| 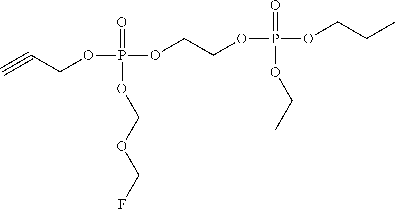 [SMILES: C#CCOP(=O)(OCCOP(=O)(OCC)OCCC)OCOCF] | Compound 13 |
| 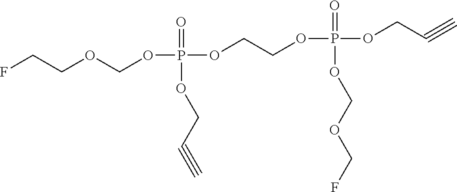 [SMILES: C#CCOP(=O)(OCCOP(=O)(OCC#C)OCOCCF)OCOCF] | Compound 14 |
| 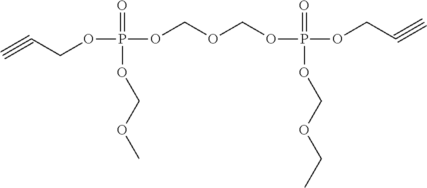 [SMILES: C#CCOP(=O)(OCOC)OCOCOP(=O)(OCC#C)OCOCC] | Compound 15 |
| 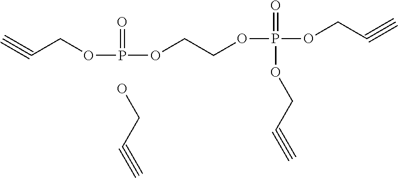 | Compound 16 |
| 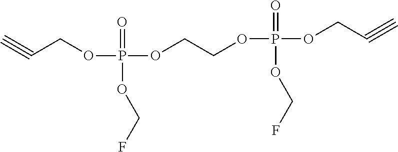 [SMILES: C#CCOP(=O)(OCF)OCCOP(=O)(OCF)OCC#C] | Compound 17 |
| 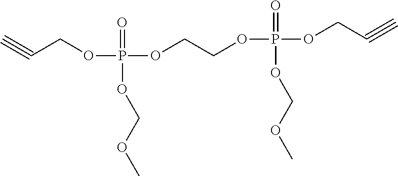 [SMILES: C#CCOP(=O)(OCCOP(=O)(OCC#C)OCOC)OCOC] | Compound 18 |
| 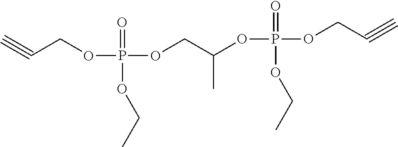 [SMILES: C#CCOP(=O)(OCC)OCC(C)OP(=O)(OCC)OCC#C] | Compound 19 |
| 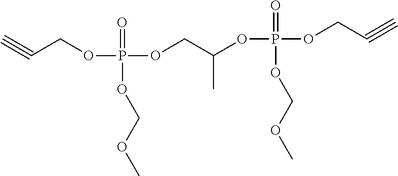 [SMILES: C#CCOP(=O)(OCOC)OCC(C)OP(=O)(OCC#C)OCOC] | Compound 20 |
| 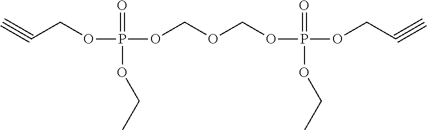 [SMILES: C#CCOP(=O)(OCC)OCOCOP(=O)(OCC)OCC#C] | Compound 21 |
| 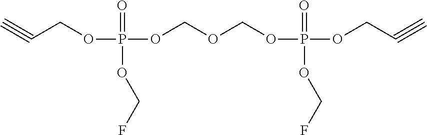 [SMILES: C#CCOP(=O)(OCF)OCOCOP(=O)(OCF)OCC#C] | Compound 22 |

As a further preferred solution of the present application, the compounds represented by Formula 2 are compounds 23-28 listed in Table 2 below.

TABLE 2
Representative preferred compounds 23-28 of the compounds
represented by Formula 2 of the present application

| | |
|---|---|
| 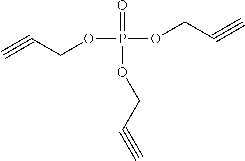 | Compound 23 |
| 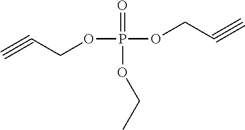 | Compound 24 |
| 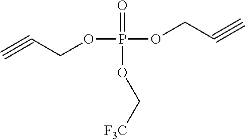 [SMILES: C#CCOP(=O)(OCC#C)OCC(F)(F)F] | Compound 25 |
| 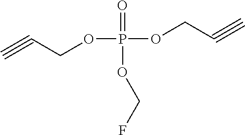 | Compound 26 |
| 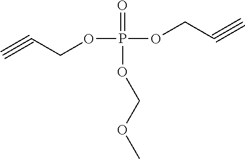 | Compound 27 |
| 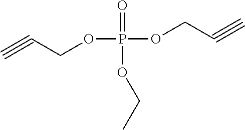 | Compound 28 |

As a preferred solution of the present application, the content of the compound represented by Formula 1 is above 10 ppm relative to the total mass of the non-aqueous electrolyte, and further, the content of the compound represented by Formula 1 is below 2% relative to the total mass of the non-aqueous electrolyte. The content of the compound represented by Formula 2 is 0.1-2% relative to the total mass of the non-aqueous electrolyte. For example, the content of the compound represented by Formula 1 is 10 ppm-2%, 20 ppm-1%, 50 ppm-0.5%, 100 ppm-0.3%, 200 ppm-0.2%, 300-1000 ppm and 500-800 ppm, or any value between them. For example, the content of the compound represented by Formula 2 is 0.1-2%, 0.3-1.8%, 0.5-1.5%, 0.8-1.2% and 1-1.1% relative to the total mass of the non-aqueous electrolyte, or any value between them.

As a further preferred solution of the present application, the non-aqueous electrolyte for a lithium ion battery further includes at least one of unsaturated cyclic carbonate, fluorinated cyclic carbonate, cyclic sulfonate lactone and cyclic sulfate as film-forming additive. Based on the total mass of the non-aqueous electrolyte, the content of unsaturated cyclic carbonate, fluorinated cyclic carbonate, cyclic sulfonate lactone and cyclic sulfate is 0.1-5%, 0.1-30%, 0.1-5% and 0.1-5% respectively.

As a further preferred solution of the present application, the unsaturated cyclic carbonate is selected from at least one of vinylene carbonate (CAS: 82-36-6), vinylethylene carbonate (CAS: 4427-96-7) and methylene ethylene carbonate (CAS: 124222-05-5), the fluorinated cyclic carbonate is selected from at least one of fluoroethylene carbonate (CAS: 114435-02-8), trifluoromethyl ethylene carbonate (CAS: 167951-80-6) and difluoroethylene carbonate (CAS: 311810-76-1), and the cyclic sulfonate lactone is selected from at least one of 1,3-propane suhone (CAS: 1120-71-4), 1,4-butane sultone (CAS: 1633-83-6) and propene 1,3-sultone (CAS: 21806-61-1), and the cyclic sulfate is selected from at least one of ethylene sulfate (CAS: 1072-53-3) and 4-methyl ethylene sulfate (CAS: 5689-83-8).

As a further preferred solution of the present application, the non-aqueous organic solvent is a mixture of cyclic carbonate and chain carbonate.

Preferably, the cyclic carbonate is selected from at least one of ethylene carbonate, propylene carbonate and butylene carbonate, and the chain carbonate is selected from at least one of dimethyl carbonate, diethyl carbonate, methyl ethyl carbonate and methyl propyl carbonate; the lithium salt is selected from at least one of LiPF₆, LiBF₄, LiPO₂F₂, LiTFSI, LiBOB, LiDFOB and LiN(SO₂F)₂.

According to a second aspect of the present application, the present application provides a lithium ion battery, which includes a positive electrode, a negative electrode, and a separator disposed between the positive electrode and the negative electrode, and further includes the non-aqueous electrolyte for a lithium ion battery according to the first aspect of the present application.

As a further preferred solution of the present application, the positive electrode includes a positive electrode active material selected from at least one of LiNiₓCo_{y}Mn_{z}L_{(1-x-y-z)}O₂, LiCo_{x′}L_{(1-x′)} O₂, LiNi_{x″}L′_{y′}Mn_{(2-x″-y′)}O₄ and Li_{z′}MPO₄, wherein L is at least one of Al, Sr, Mg, Ti, Ca, Zr, Zn, Si or Fe, 0≤x≤1, 0≤y≤1, 0≤z≤1, 0<x+y+z≤1, 0<x′≤1, 0.3≤x″≤0.6, 0.01≤y′≤0.2, L′ is at least one of Co, Al, Sr, Mg, Ti, Ca, Zr, Zn, Si and Fe; 0.5≤z′≤1, M is at least one of Fe, Mn and Co.

Although the mechanism of action of the compound represented by Formula 1 in the non-aqueous electrolyte for a lithium ion battery of the present application is not very clear, the inventors speculate that the compound represented by Formula 1 is able to polymerize to form a passivation film on the electrode surface during the first charge of lithium ion battery due to the presence of at least one unsaturated hydrocarbon group, thereby inhibiting the further decomposition of organic solvent molecules. In addition, the compound represented by Formula 1 can react with LiF to reduce the content of high-impedance component LiF in the passivation film on the electrode surface, which is favorable for the passage of lithium ions, thus significantly improving the high-temperature storage performance and cycle performance of lithium ion batteries. Furthermore, in the compound represented by Formula 1, two phosphate groups are connected by flexible alkylene or ether groups, which is more conducive to dispersion and reaction in the electrolyte compared with more rigid alkynyl groups, so as to further improve the high-temperature storage performance and cycle performance of lithium ion batteries, and to some extent, inhibit the decline of low-temperature performance.

The inventors believe that the compound represented by Formula 1 and the compound represented by Formula 2 play a synergistic role, although the mechanism of the synergistic effect is not very clear. The content of the compound represented by Formula 1 is more than 10 ppm relative to the total mass of the non-aqueous electrolyte. When it is less than 10 ppm, it may be difficult to fully form a passivation film on the positive and negative electrode surfaces, and it is difficult to play a synergistic role with the compound is represented by Formula 2, thus it is difficult to fully improve the high-temperature storage performance of the non-aqueous electrolyte battery. The content of the compound represented by Formula 1 is less than 2% relative to the total mass of the non-aqueous electrolyte. When it exceeds 2%, an excessively thick passivation film may be formed on the positive and negative electrode surfaces, increasing the internal resistance of the battery, thus reducing the cycle performance of the battery and increasing the cost of electrolyte. Similarly, it is preferable that the content of the compound represented by Formula 2 is 0.1-2% relative to the total mass of the non-aqueous electrolyte, so as to play a synergistic role with the compound represented by Formula 1 and avoid the formation of an excessively thick passivation film on the positive and negative electrode surfaces.

The non-aqueous electrolyte for a lithium ion battery also includeds at least one of unsaturated cyclic carbonate, fluorinated cyclic carbonate, cyclic sulfonate lactone and cyclic sulfate as film-forming additive, which can form a more stable SEI film on the surface of negative graphite electrode, thus significantly improving the cycle performance of lithium ion battery.

In the non-aqueous electrolyte for a lithium ion battery, the mixed solution of cyclic carbonate organic solvent with high dielectric constant and chain carbonate organic solvent with low viscosity is used as the solvent of the lithium ion battery electrolyte, so that the mixed solution of organic solvent has high ionic conductivity, high dielectric constant and low viscosity at the same time.

### DETAILED DESCRIPTION OF DISCLOSED EMBODIMENTS

The application is described in further detail below with specific embodiments and drawings. In which like element in different embodiments have been label with like reference signs. In the following embodiments, many details are set forth in order to provide a better understanding of the present application. However, those skilled in the art would readily recognize that some of the features may be omitted in various instances or may be replaced by other elements, materials, methods. In some instances, operations related to this application are not shown or described in the specification in order to avoid obscuring the core part of this application with too much description, and a detailed description of these operations is not necessary for those skilled in the art. They can fully understand the related operations according to the description in the specification and common technical knowledge in the art.

In addition, features, operations, or characteristics described in the specification may be combined in any suitable manner to form various embodiments. Also, the steps or operations in the method description may be sequentially reversed or adjusted in ways that would be apparent to those skilled in the art. Accordingly, the various orders in the specification and drawings are for clarity of description of a particular embodiment only and do not intend to be a necessary order unless otherwise specified in which a particular order is to be followed.

The application provides a non-aqueous electrolyte for a lithium ion battery, including a non-aqueous organic solvent and a lithium salt, the non-aqueous electrolyte further includes one or more selected from the group consisting of compounds represented by Formula 1 and compounds represented by Formula 2;

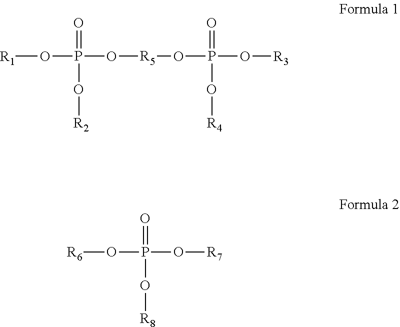

in Formula 1, R₁, R₂, R₃ and R₄ are each independently selected from a substituted or unsubstituted alkyl group of 1-5 carbon atoms, a substituted or unsubstituted ether group of 1-5 carbon atoms and a substituted or unsubstituted unsaturated hydrocarbon group of 2-5 carbon atoms, provided that at least one of R₁, R₂, R₃ and R₄ is the substituted or unsubstituted unsaturated hydrocarbon group of 2-5 carbon atoms, and R₅ is selected from a substituted or unsubstituted alkylene group of 1-5 carbon atoms and a substituted or unsubstituted ether group of 1-5 carbon atoms;

in Formula 2, R₆, R₇ and R₈ are each independently selected from a substituted or unsubstituted alkyl group of 1-5 carbon atoms, a substituted or unsubstituted ether group of 1-5 carbon atoms and a substituted or unsubstituted unsaturated hydrocarbon group of 2-5 carbon atoms, provided that at least one of R₆, R₇ and R₈ is the substituted or unsubstituted unsaturated hydrocarbon group of 2-5 carbon atoms.

The alkyl group of 1-5 carbon atoms may be selected from, for example, methyl, ethyl, n-propyl, isopropyl, n-butyl, isobutyl, sec-butyl, tert-butyl, n-pentyl, isopentyl, sec-pentyl and neopentyl.

The unsaturated hydrocarbon group of 2-5 carbon atoms may be selected from vinyl, propenyl, allyl, butenyl, pentenyl, methyl vinyl, methyl allyl, ethynyl, propinyl, propargyl, butynyl and pentynyl.

The alkylene group of 1-5 carbon atoms is selected from methylene, ethylidene, n-propylene, isopropylidene, n-butylene, isobutylidene, sec-butylidene, tertiary butyl, pentylene, isoamylidene, sec-pentylene and neopentylidene.

The ether group of 1-5 carbon atoms is selected from a methyl ether, diethyl ether, methyl ethyl ether, propyl ether, methyl propyl ether and ethyl propyl ether.

The “substituted” is that one or more hydrogen elements are substituted by halogen; preferably, the halogen is fluorine, chlorine, bromine and iodine; more preferably, the halogen is fluorine.

Specifically, the halogen-substituted alkyl group of 1-5 carbon atoms is a fluoroalkyl group of 1-5 carbon atoms obtained by replacing one or more hydrogen elements in the alkyl group of 1-5 carbon atoms with a fluorine element.

Specifically, the halogen-substituted unsaturated hydrocarbon group of 2-5 carbon atoms is a fluorinated unsaturated hydrocarbon group of 2-5 carbon atoms obtained by replacing one or more hydrogen elements in the unsaturated hydrocarbon group of 2-5 carbon atoms with a fluorine element.

Specifically, the halogen-substituted alkylene group of 1-5 carbon atoms is a fluoroalkylene group of 1-5 carbon atoms obtained by replacing one or more hydrogen elements in the alkylene group of 1-5 carbon atoms with a fluorine element.

Specifically, the halogen-substituted ether group of 1-5 carbon atoms is a fluoroether group of 1-5 carbon atoms obtained by replacing one or more hydrogen elements in the ether group of 1-5 carbon atoms with a fluorine element.

Specifically, the fluoroether group of 1-5 carbon atoms may be selected from, for example, fluoromethyl ether, fluoroethyl ether, fluoromethyl ethyl ether, fluoropropyl ether, fluoropropyl methyl ether and fluoropropyl ethyl ether.

Those skilled in the art, knowing the structural formula of the above compounds of Formula 1, may be aware of the preparation method of the above-mentioned compound according to the common knowledge in the field of chemical synthesis. For example, the compound of Formula 1 may be prepared by using triethylamine as acid-binding agent. In ether solvent, phosphorus oxychloride reacts with corresponding alcohols at low temperature (−10° C. to 0° C.) and normal pressure to generate corresponding phosphate, which is then purified by recrystallization or column chromatography. Take compounds 1, 6 and 15 as examples, and their synthetic routes are as follows:

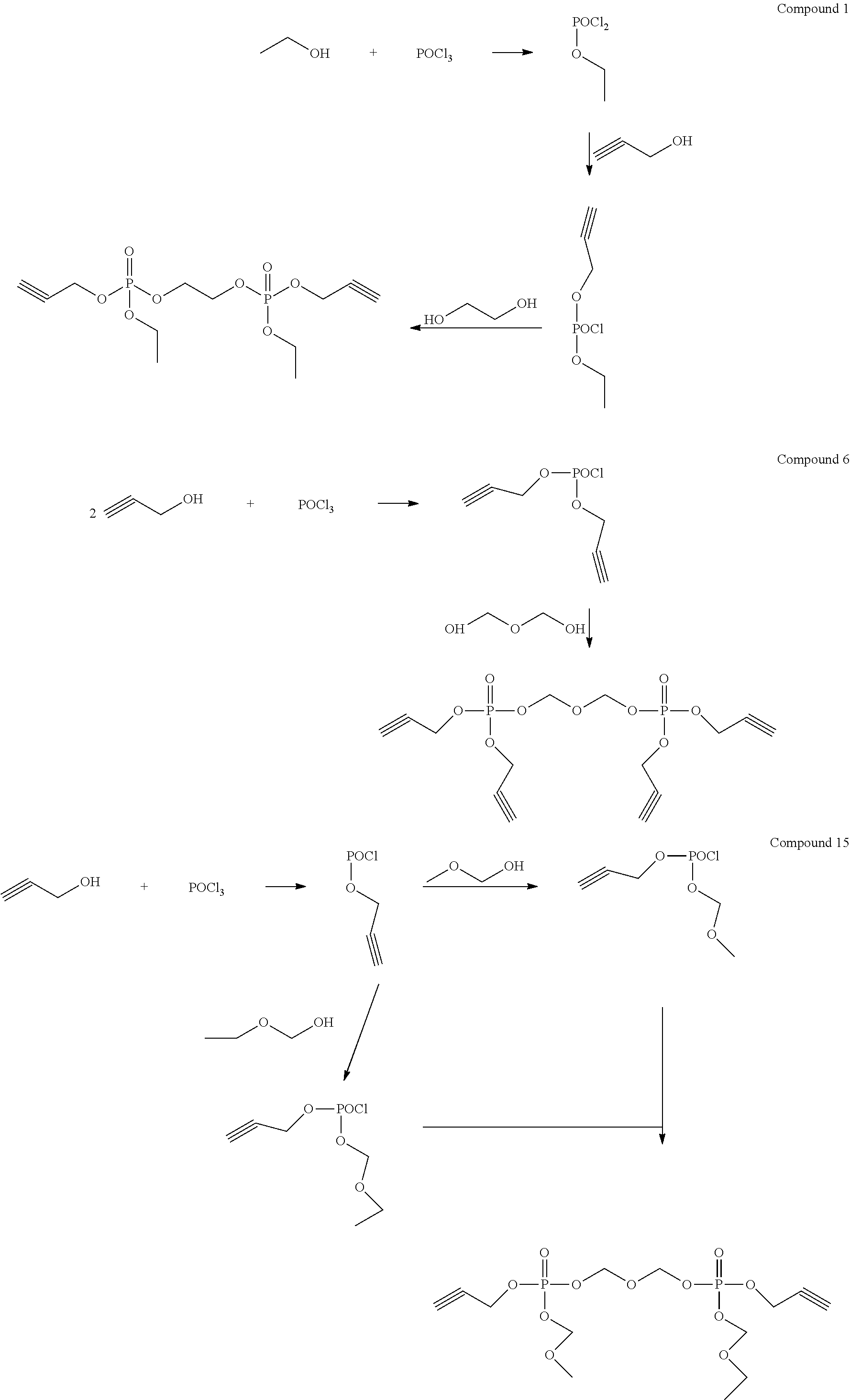

In addition, the present application provides a lithium ion battery, which includes a positive electrode, a negative electrode, and a separator disposed between the positive electrode and the negative electrode, and the non-aqueous electrolyte for a lithium ion battery mentioned above.

The present application will be further described in detail below with non-limiting embodiments and comparative examples.

### I. Embodiments 1-17 and Comparative Examples 1-7

### 1) Preparation of Electrolyte

Ethylene carbonate (EC), diethyl carbonate (DEC) and ethyl methyl carbonate (EMC) were mixed according to the mass ratio of EC:DEC:EMC=1:1:1, and then lithium hexafluorophosphate (LiPF₆) was added till the molar concentration was 1 mol/L to prepare the basic electrolyte. Then, as shown in Table 2, a specified amount of compound represented by Formula 1 listed in Table 1 and/or a specified amount of compound represented by Formula 2 and other compounds are added or not.

Specifically, based on the total mass of the basic electrolyte, 1% of Compound 23 was added in Embodiments 1-11 and Comparative Examples 1-6. On this basis, 20 ppm of Compound 1, 50 ppm of Compound 2, 100 ppm of Compound 4, 500 ppm of Compound 7, 1000 ppm of Compound 8 and 1% of Compound 12 were added in Embodiments 1-6, respectively. 500 ppm of Compound 1 and 1% vinylene carbonate (VC), 500 ppm of Compound 1 and 1% fluoroethylene carbonate (FEC), 500 ppm of Compound 1 and 1% of 1,3-propane sultone (PS), 500 ppm of Compound 1 and 1% of ethylene sulfate (DTD) and 500 ppm of Compound 1 and 1% LiN(SO₂F)₂ were added in Embodiments 7-11, respectively. compounds represented by Formula 1 were not added in Comparative Example 1. compounds represented by Formula 1 were not added in Comparative Examples 2-6, but 1% VC, 1% FEC, 1% PS, 1% DTD and 1% LiN(SO₂F)₂ were added, respectively.

In Embodiment 12, only 20 ppm of Compound 1 was added. In Embodiments 13-17, 500 ppm of Compound 7 was added, on this basis, 0.1%, 0.2%, 0.5%, 1.5% and 2.0% of Compound 23 were added respectively. In Comparative Example 7, 500 ppm of 2-alkynyl-1,4-bis (bis (2-propinyl)) phosphate (ABPP) was added.

### 2) Preparation of Positive Electrode

Positive electrode active material lithium nickel cobalt manganese oxide LiNi_{0.6}Co_{0.2}Mn_{0.2}O₂, conductive carbon black Super-P and binder Poly(vinylidene fluoride) (PVDF) were mixed according to the mass ratio of 93:4:3, and then the mixture was dispersed in N-methyl-2-pyrrolidone (NMP) to obtain a positive electrode slurry. The slurry was uniformly coated on both sides of the aluminum foil, dried, calendered and vacuum-dried, and an aluminum lead wire was welded by an ultrasonic welding machine to obtain a positive electrode plate with a thickness of 120-150 μm.

### 3) Preparation of Negative Electrode

Negative electrode active material artificial graphite, conductive carbon black Super-P, binder styrene butadiene rubber (SBR) and carboxymethyl cellulose (CMC) were mixed according to the mass ratio of 94:1:2.5:2.5, and then the mixture was dispersed in deionized water to obtain a negative electrode slurry. The slurry was coated on both sides of the copper foil, dried, calendered and vacuum-dried, and the nickel lead wire was welded by an ultrasonic welding machine to obtain a negative electrode plate with a thickness of 120-150 μm.

### 4) Preparation of Battery Core

A three-layer separator with a thickness of 20 μm was placed between the positive electrode plate and negative electrode plate. And then the sandwich structure composed of the positive electrode plate, the negative electrode plate and the separator was wound. Then the winding body was flattened and placed in an aluminum foil packaging bag, vacuum-baked at 75° C. for 48 hours to obtain an unfilled battery core.

### 5) Injection and Formation of Battery Core

In a glove box with dew point controlled below −40° C., the electrolyte prepared above was injected into the battery core, and then vacuum packed to make a lithium ion battery, which was let stand for 24 hours.

Then follow the steps below to carry out the formation of the first charge: charging at 0.05 C constant current for 180 min, charging at 0.2 C constant current to 3.95V, vacuum sealing for the second time, then further charging to 4.4V at 0.2 C constant current, and then discharging to 3.0V at 0.2 C constant current after letting stand for 24 h.

### II. Embodiments 18-24 and Comparative Examples 8-9

The basic electrolyte was prepared according to the method described in “I. Embodiments 1-17 and Comparative Examples 1-7” above, and then as shown in Table 3, a specified amount of compounds represented by Formula 1 and/or a specified amount of compounds represented by Formula 2 and other compounds were added or not. Specifically, according to the total mass of the electrolyte, 1% of Compound 26 was added in Embodiments 18-23 and Comparative Example 8. On this basis, 20 ppm of Compound 1, 50 ppm of Compound 2, 100 ppm of Compound 4, 500 ppm of Compound 7, 1000 ppm of Compound 8 and 1% of Compound 12 were added in Embodiments 18-23 respectively. compounds represented by Formula 1 were not added in Comparative example 8. In Embodiment 24, Only 20 ppm of Compound 1 was added. In Comparative example 9, only 500 ppm of 2-alkynyl-1,4-bis (bis (2-propinyl)) phosphate (ABPP) was added. In addition, the positive electrode active components of Embodiments 18-14 and Comparative Examples 8-9 were all LiNi_{0.8}Co_{0.15}Al_{0.05}O₂ for preparing the positive electrode plate. According to the method described in “I. Embodiments 1-17 and Comparative Examples 1-7” above, the positive electrode plate and battery core were prepared, and the battery core was injected and formed.

### II. Embodiments 25-31 and Comparative Examples 10-11

The basic electrolyte was prepared according to the method described in “I. Embodiments 1-17 and Comparative Examples 1-7” above, and then as shown in Table 4, a specified amount of compounds represented by Formula 1 listed in Table 1 and/or a specified amount of compounds represented by Formula 2 and other compounds were added or not. Specifically, according to the total mass of the electrolyte, 1% of Compound 27 was added in Embodiments 25-30 and Comparative Example 10. On this basis, 20 ppm of Compound 1, 50 ppm of Compound 2, 100 ppm of Compound 4, 500 ppm of Compound 7, 1000 ppm of Compound 10 and 1% of Compound 12 were added in Embodiments 25-30 respectively. compounds represented by Formula 1 were not added in Comparative example 8. In Embodiment 31, Only 20 ppm of Compound 1 was added. In Comparative example 11, only 500 ppm of 2-alkynyl-1,4-bis (bis (2-propinyl)) phosphate (ABPP) was added. In addition, the positive electrode active components of Embodiments 25-31 and Comparative Examples 10-11 were all LiCoO₂ for preparing the positive electrode plate. According to the method described in “I. Embodiments 1-17 and Comparative Examples 1-7” above, the negative electrode plate and battery core were prepared, and the battery core was injected and formed.

### Performance Tests of Lithium Ion Batteries Made in Embodiments and Comparative Examples

In order to verify the influence of the non-aqueous electrolyte for a lithium ion battery of the present application on the battery performance, the related performance tests of the lithium ion batteries made in Embodiments 1-31 and Comparative Examples 1-11 were carried out below. The test performance includes high-temperature cycle performance test, high-temperature storage performance test and low-temperature performance test. The specific test methods are as follows:

### 1. High-Temperature Cycle Performance Test

The lithium ion batteries made in Embodiments 1-31 and Comparative Examples 1-11 were placed in an oven with a constant temperature of 45° C., and charged to 4.4 V (LiNi_{0.6}Co_{0.2}Mn_{0.2}O₂/artificial graphite battery, LiCoO₂/artificial graphite battery) or 4.2 V (LiNi_{0.8}Co_{0.15}Al_{0.05}O₂/artificial graphite battery) at 1 C constant current, and then charged at constant voltage until the current dropped to 0.02 C, then discharged to 3.0 V at 1 C constant current. This cycle was repeated, and the first discharge capacity and the last discharge capacity were recorded.

The capacity retention rate of high-temperature cycle performance was calculated according to the following formula:

Battery capacity retention rate (%)=last discharge capacity/first discharge capacity×100%%.

### 2. High-Temperature Storage Performance Test

The lithium ion batteries made in Embodiments 1-31 and Comparative Examples 1-11 were charged to 4.4 V (LiNi_{0.6}Co_{0.2}Mn_{0.2}O₂/artificial graphite battery, LiCoO₂/artificial graphite battery) or 4.2 V (LiNi_{0.8}Co_{0.15}Al_{0.05}O₂/artificial graphite battery) at a constant current and constant voltage of 1 C at a normal temperature after being formed. Measure the initial discharge capacity and initial battery thickness of the battery. And then the batteries were discharged to 3 V at 1 C after being stored at 60° C. for 30 days. Measure the retention capacity and recovery capacity of the battery and the thickness of the battery after storage. The formulas are as follows:

Battery capacity retention rate (%)=retention capacity/initial capacity×100%;

Battery capacity recovery rate (%)=recovery capacity/initial capacity×100%;

Thickness expansion rate (%)=(battery thickness after storage−initial battery thickness)/initial battery thickness×100%.

### 3. Low-Temperature Performance Test

The lithium ion batteries made in Embodiments 1-31 and Comparative Examples 1-11 were charged to 4.4 V(LiNi_{0.6}Co_{0.2}Mn_{0.2}O₂/artificial graphite battery) or 4.2 V (LiNi_{0.8}Co_{0.15}Al_{0.05}O₂/artificial graphite battery) at 25° C. after formation, and then discharged to 3.0 V at 1 C constant current, and the discharge capacity was recorded. Then the batteries were charged to 4.4V (LiNi_{0.6}Co_{0.2}Mn_{0.2}O₂/artificial graphite battery, LiCoO₂/artificial graphite battery) or 4.2V (LiNi_{0.8}Co_{0.15}Al_{0.05}O₂/artificial graphite battery) at 1 C constant current and constant voltage, let stand at −20° C. for 12 hours, then discharged to 3.0 V at 0.2 C constant current, and the discharge capacity was recorded.

Low-temperature discharge efficiency (−20° C.)=discharge capacity (0.2 C,−20° C.)/discharge capacity (1 C,25° C.)×100%.

TABLE 2
Positive electrode active components, electrolyte composition and battery performance of
lithium ion batteries of Embodiments 1-17 and Comparative Examples 1-7

| | | | | | | | | | Discharge |
|---|---|---|---|---|---|---|---|---|---|
| | | compounds | compounds | | Capacity | | | | capacity |
| | | represented | represented | Other | retention | Storage for 30 days at 60° C. | | | retention |
| | | by Formula | by Formula | compounds | rate after | Capacity | Capacity | Thickness | rate |
| | Positive electrode | 1 and their | 2 and their | and | 500 cycles | retention | recovery | expansion | (0.2C, |
| Embodiments | active component | contents | contents | contents | at 45° C., 1 C | rate | rate | rate | −20° C.) |
| Embodiment | LiNi_{0.6}Co_{0.2}Mn_{0.2}O₂ | Compound | Compound | / | 80.5% | 79.9% | 86.0% | 13.6% | 71.6% |
| 1 | | 1: 20 ppm | 23: 1% | | | | | | |
| Embodiment | LiNi_{0.6}Co_{0.2}Mn_{0.2}O₂ | Compound | Compound | / | 82.7% | 82.7% | 87.9% | 11.4% | 74.4% |
| 2 | | 2: 50 ppm | 23: 1% | | | | | | |
| Embodiment | LiNi_{0.6}Co_{0.2}Mn_{0.2}O₂ | Compound | Compound | / | 87.9% | 82.8% | 89.3% | 9.3% | 72.7% |
| 3 | | 4: 100 ppm | 23: 1% | | | | | | |
| Embodiment | LiNi_{0.6}Co_{0.2}Mn_{0.2}O₂ | Compound | Compound | / | 89.6% | 85.6% | 90.2% | 7.7% | 71.2% |
| 4 | | 7: 500 ppm | 23: 1% | | | | | | |
| Embodiment | LiNi_{0.6}Co_{0.2}Mn_{0.2}O₂ | Compound | Compound | / | 88.7% | 86.3% | 90.8% | 6.0% | 69.9% |
| 5 | | 8: 1000 ppm | 23: 1% | | | | | | |
| Embodiment | LiNi_{0.6}Co_{0.2}Mn_{0.2}O₂ | Compound | Compound | / | 87.4% | 85.1% | 88.7% | 7.2% | 68.8% |
| 6 | | 12: 1% | 23: 1% | | | | | | |
| Embodiment | LiNi_{0.6}Co_{0.2}Mn_{0.2}O₂ | Compound | Compound | VC: 1% | 90.9% | 87.8% | 92.3% | 12.5% | 69.6% |
| 7 | | 1: 500 ppm | 23: 1% | | | | | | |
| Embodiment | LiNi_{0.6}Co_{0.2}Mn_{0.2}O₂ | Compound | Compound | FEC: 1% | 88.6% | 86.3% | 90.5% | 15.4% | 74.8% |
| 8 | | 1: 500 ppm | 23: 1% | | | | | | |
| Embodiment | LiNi_{0.6}Co_{0.2}Mn_{0.2}O₂ | Compound | Compound | PS: 1% | 82.6% | 85.4% | 92.9% | 7.9% | 68.7% |
| 9 | | 1: 500 ppm | 23: 1% | | | | | | |
| Embodiment | LiNi_{0.6}Co_{0.2}Mn_{0.2}O₂ | Compound | Compound | DTD: 1% | 87.6% | 86.6% | 90.1% | 14.3% | 76.7% |
| 10 | | 1: 500 ppm | 23: 1% | | | | | | |
| Embodiment | LiNi_{0.6}Co_{0.2}Mn_{0.2}O₂ | Compound | Compound | LiN(SO₂F) | 86.7% | 87.8% | 91.5% | 10.9% | 80.7% |
| 11 | | 1: 500 ppm | 23: 1% | 2: 1% | | | | | |
| Embodiment | LiNi_{0.6}Co_{0.2}Mn_{0.2}O₂ | Compound 1: | / | / | 79.2% | 78.6% | 84.7% | 14.7% | 70.3% |
| 12 | | 20 ppm | | | | | | | |
| Embodiment | LiNi_{0.6}Co_{0.2}Mn_{0.2}O₂ | Compound | Compound | / | 70.3% | 69.5.% | 78.0% | 10.7% | 61.5% |
| 13 | | 7: 500 ppm | 23: 0.1% | | | | | | |
| Embodiment | LiNi_{0.6}Co_{0.2}Mn_{0.2}O₂ | Compound | Compound | / | 79.6% | 76.3% | 82.7% | 8.9% | 63.6% |
| 14 | | 7: 500 ppm | 23: 0.2% | | | | | | |
| Embodiment | LiNi_{0.6}Co_{0.2}Mn_{0.2}O₂ | Compound | Compound | / | 83.6% | 82.5% | 87.8% | 7.8% | 68.1% |
| 15 | | 7: 500 ppm | 23: 0.5% | | | | | | |
| Embodiment | LiNi_{0.6}Co_{0.2}Mn_{0.2}O₂ | Compound | Compound | / | 87.5% | 84.3% | 89.2% | 8.7% | 70.3% |
| 16 | | 7: 500 ppm | 23: 1.5% | | | | | | |
| Embodiment | LiNi_{0.6}Co_{0.2}Mn_{0.2}O₂ | Compound | Compound | / | 85.3% | 83.7% | 86.7% | 9.7% | 69.8% |
| 17 | | 7: 500 ppm | 23: 2.0% | | | | | | |
| Comparative | LiNi_{0.6}Co_{0.2}Mn_{0.2}O₂ | / | Compound | / | 62.3% | 67.7% | 71.9% | 18.6% | 67.6% |
| Example 1 | | | 23: 1% | | | | | | |
| Comparative | LiNi_{0.6}Co_{0.2}Mn_{0.2}O₂ | / | Compound | VC: 1% | 77.2% | 76.0% | 79.9% | 27.0% | 65.8% |
| Example 2 | | | 23: 1% | | | | | | |
| Comparative | LiNi_{0.6}Co_{0.2}Mn_{0.2}O₂ | / | Compound | FEC: 1% | 79.1% | 73.9% | 79.2% | 28.2% | 72.3% |
| Example 3 | | | 23: 1% | | | | | | |
| Comparative | LiNi_{0.6}Co_{0.2}Mn_{0.2}O₂ | / | Compound | PS: 1% | 72.5% | 77.3% | 82.0% | 17.1% | 66.1% |
| Example 4 | | | 23: 1% | | | | | | |
| Comparative | LiNi_{0.6}Co_{0.2}Mn_{0.2}O₂ | / | Compound | DTD | 76.5% | 76.3% | 79.5% | 14.9% | 75.5% |
| Example 5 | | | 23: 1% | | | | | | |
| Comparative | LiNi_{0.6}Co_{0.2}Mn_{0.2}O₂ | / | Compound | LiN(SO₂F) | 74.5% | 78.2% | 82.5% | 15.7% | 74.7% |
| Example 6 | | | 23: 1% | 2: 1% | | | | | |
| Comparative | LiNi_{0.6}Co_{0.2}Mn_{0.2}O₂ | / | Compound | ABPP: | 68.1% | 68.9% | 76.4% | 18.1% | 61.3% |
| Example 7 | | | 23: 1% | 500 ppm | | | | | |

It can be seen from the data in Table 2 that when LiNi_{0.6}Co_{0.2}Mn_{0.2}O₂ was used as the positive electrode active component, compared with Comparative Example 1, the high-temperature cycle performance, high-temperature storage performance and low-temperature performance of the corresponding lithium ion batteries of Embodiments 1-6 were significantly improved because of the addition of the representative compounds represented by Formula 1 whose contents were 20 ppm-1% relative to the total mass of the non-aqueous electrolyte for a lithium ion battery. Compared with Comparative Examples 2-6, the non-aqueous electrolyte for a lithium ion battery of Embodiments 7-11 contains 500 ppm of Compound 1 in addition to other compounds, and the high-temperature cycle performance, high-temperature storage performance and low-temperature performance of the corresponding lithium ion batteries were also significantly improved. Comparing Embodiment 4 with Embodiments 13-17, the high-temperature cycle performance, high-temperature storage performance and low-temperature performance of the lithium ion batteries were the best when the content of the compound represented by Formula 2 added in the non-aqueous electrolyte for a lithium ion battery is 1%. Therefore, for the following lithium ion batteries designed in Tables 3 and 4, the concentration of the compound represented by Formula 2 was 1%. Compared with Embodiment 12, the compound represented by Formula 2 in an amount of 1% relative to the total mass of non-aqueous electrolyte for a lithium ion battery was added in Embodiment 1, and the high-temperature cycle performance, high-temperature storage performance and low-temperature performance of the corresponding lithium ion battery were also improved. Compared with Comparative Example 7, in which 2-alkynyl-1,4-bis (bis (2-propinyl)) phosphate (ABPP) with a content of 500 ppm relative to the total mass of non-aqueous electrolyte for a lithium ion battery was added, the high-temperature cycle performance, high-temperature storage performance and low-temperature performance of the corresponding lithium-ion batteries of Embodiments 1-6 were significantly improved due to the addition of the representative compounds represented by Formula 1 with a content of 20 ppm-1% and the compounds represented by Formula 2 with a content of 1% relative to the total mass of the non-aqueous electrolyte for a lithium-ion battery. However, the use of ABPP in Comparative Example 7 also leaded to the decrease of low-temperature performance to some extent.

TABLE 3
Positive electrode active components, electrolyte composition and battery performance
of lithium ion batteries of Embodiments 18-24 and Comparative Examples 8-9

| | | | | | Capacity | | | | |
|---|---|---|---|---|---|---|---|---|---|
| | | compounds | compounds | | retention | | | | Discharge |
| | | represented | represented | Other | rate after | Storage for 30 days at 60° C. | | | capacity |
| | | by Formula | by Formula | compounds | 500 cycles | Capacity | Capacity | Thickness | retention |
| | Positive electrode | 1 and their | 2 and their | and | at 45° C., | retention | recovery | expansion | rate (0.2C, |
| Embodiments | active component | contents | contents | contents | 1 C | rate | rate | rate | −20° C.) |
| Embodiment 18 | LiNi_{0.8}Co_{0.15}Al_{0.05}O₂ | Compound | Compound | / | 77.5% | 72.9% | 76.2% | 25.5% | 72.4% |
| | | 1: 20 ppm | 26: 1% | | | | | | |
| Embodiment 19 | LiNi_{0.8}Co_{0.15}Al_{0.05}O₂ | Compound | Compound | / | 82.6% | 77.8% | 82.6% | 25.2% | 72.4% |
| | | 2: 50 ppm | 26: 1% | | | | | | |
| Embodiment 20 | LiNi_{0.8}Co_{0.15}Al_{0.05}O₂ | Compound | Compound | / | 87.1% | 82.6% | 86.3% | 16.2% | 70.4% |
| | | 4: 100 ppm | 26: 1% | | | | | | |
| Embodiment 21 | LiNi_{0.8}Co_{0.15}Al_{0.05}O₂ | Compound | Compound | / | 86.6% | 84.6% | 88.5% | 13.3% | 69.9% |
| | | 7: 500 ppm | 26: 1% | | | | | | |
| Embodiment 22 | LiNi_{0.8}Co_{0.15}Al_{0.05}O₂ | Compound | Compound | / | 87.6% | 85.7% | 90.3% | 9.2% | 72.0% |
| | | 8: | 26: 1% | | | | | | |
| | | 1000 ppm | | | | | | | |
| Embodiment 23 | LiNi_{0.8}Co_{0.15}Al_{0.05}O₂ | Compound | Compound | / | 85.7% | 87.3% | 91.9% | 6.0% | 69.3% |
| | | 12: 1% | 26: 1% | | | | | | |
| Embodiment 24 | LiNi_{0.8}Co_{0.15}Al_{0.05}O₂ | Compound | / | / | 76.2% | 71.6% | 74.9% | 26.6% | 71.3% |
| | | 1: 20 ppm | | | | | | | |
| Comparative | LiNi_{0.8}Co_{0.15}Al_{0.05}O₂ | / | Compound | / | 67.3% | 62.5% | 66.0% | 38.1% | 68.2% |
| Example 8 | | | 26: 1% | | | | | | |
| Comparative | LiNi_{0.8}Co_{0.15}Al_{0.05}O₂ | / | Compound | ABPP: | 70.2% | 66.7% | 68.3% | 33.8% | 60.9% |
| Example 9 | | | 26: 1% | 500 ppm | | | | | |

It can be seen from the data in Table 3 that when _{0.8}Co_{0.15}Al_{0.05}O₂ was used as the positive electrode active component, compared with Comparative Example 8, the high-temperature cycle performance, high-temperature storage performance and low-temperature performance of the corresponding lithium ion batteries of Embodiments 18-23 were significantly improved because of the addition of the representative compounds represented by Formula 1 whose contents were 20 ppm-1% relative to the total mass of the non-aqueous electrolyte for a lithium ion battery. Compared with Embodiment 24, the compound represented by Formula 2 in an amount of 1% relative to the total mass of non-aqueous electrolyte for a lithium ion battery was added in Embodiment 18, and the high-temperature cycle performance, high-temperature storage performance and low-temperature performance of the corresponding lithium ion battery were also improved. Compared with Comparative Example 9, in which 2-alkynyl-1,4-bis (bis (2-propinyl)) phosphate (ABPP) with a content of 500 ppm relative to the total mass of non-aqueous electrolyte for a lithium ion battery was added, the high-temperature cycle performance, high-temperature storage performance and low-temperature performance of the corresponding lithium-ion batteries of Embodiments 18-23 were significantly improved due to the addition of the representative compounds represented by Formula 1 with a content of 20 ppm-1% and the compounds represented by Formula 2 with a content of 1% relative to the total mass of the non-aqueous electrolyte for a lithium-ion battery. However, the use of ABPP in Comparative Example 9 also leaded to the decrease of low-temperature performance to some extent.

TABLE 4
Positive electrode active components, electrolyte composition and battery performance
of lithium ion batteries of Embodiments 25-31 and Comparative Examples 10-11

| | | | | | Capacity | | | | |
|---|---|---|---|---|---|---|---|---|---|
| | | compounds | compounds | | retention | | | | |
| | Positive | represented | represented | Other | rate after | Storage for 30 days at 60° C. | | | Discharge |
| | electrode | by Formula | by Formula | compounds | 500 | Capacity | Capacity | Thickness | capacity |
| | active | 1 and their | 2 and their | and | cycles at | retention | recovery | expansion | retention rate |
| Embodiments | component | contents | conten | contents | 45° C., 1 C | rate | rate | rate | (0.2C, −20° C.) |
| Embodiment | LiCoO₂ | Compound 1: | Compound | / | 79.6% | 74.7% | 79.4% | 27.1% | 74.4% |
| 25 | | 20 ppm | 27: 1% | | | | | | |
| Embodiment | LiCoO₂ | Compound 2: | Compound | / | 84.9% | 79.9% | 84.7% | 27.3% | 75.8% |
| 26 | | 50 ppm | 27: 1% | | | | | | |
| Embodiment | LiCoO₂ | Compound 4: | Compound | / | 88.3% | 84.9% | 88.5% | 18.3% | 72.2% |
| 27 | | 100 ppm | 27: 1% | | | | | | |
| Embodiment | LiCoO₂ | Compound 7: | Compound | / | 90.6% | 87.9% | 89.3% | 17.9% | 73.7% |
| 28 | | 500 ppm | 27: 1% | | | | | | |
| Embodiment | LiCoO₂ | Compound 8: | Compound | / | 88.4% | 87.0% | 83.9% | 16.3% | 71.2% |
| 29 | | 1000 ppm | 27: 1% | | | | | | |
| Embodiment | LiCoO₂ | Compound | Compound | / | 87.3% | 89.4% | 91.1% | 6.7% | 70.8% |
| 30 | | 12: 1% | 27: 1% | | | | | | |
| Embodiment | LiCoO₂ | Compound 1: | | | 78.3% | 73.4% | 78.1% | 28.0% | 73.1% |
| 31 | | 20 ppm | | | | | | | |
| Comparative | LiCoO₂ | / | Compound | / | 69.4% | 64.5% | 69.7% | 38.8% | 69.9% |
| Example 10 | | | 27: 1% | | | | | | |
| Comparative | LiCoO₂ | / | Compound | ABPP: | 72.8% | 67.3% | 73.1% | 33.1% | 54.9% |
| Example 11 | | | 27: 1% | 500 ppm | | | | | |

It can be seen from the data in Table 4 that when LiCoO₂ was used as the positive electrode active component, compared with Comparative Example 10, the high-temperature cycle performance, high-temperature storage performance and low-temperature performance of the corresponding lithium ion batteries of Embodiments 25-30 were significantly improved because of the addition of the representative compounds represented by Formula 1 whose contents were 20 ppm-1% relative to the total mass of the non-aqueous electrolyte for a lithium ion battery. Compared with Embodiment 31, the compound represented by Formula 2 in an amount of 1% relative to the total mass of non-aqueous electrolyte for a lithium ion battery was added in Embodiment 25, and the high-temperature cycle performance, high-temperature storage performance and low-temperature performance of the corresponding lithium ion battery were also improved. Compared with Comparative Example 11, in which 2-alkynyl-1,4-bis (bis (2-propinyl)) phosphate (ABPP) with a content of 500 ppm relative to the total mass of non-aqueous electrolyte for a lithium ion battery was added, the high-temperature cycle performance, high-temperature storage performance and low-temperature performance of the corresponding lithium-ion batteries of Embodiments 25-30 were significantly improved due to the addition of the representative compounds represented by Formula 1 with a content of 20 ppm-1% and the compounds represented by Formula 2 with a content of 1% relative to the total mass of the non-aqueous electrolyte for a lithium-ion battery. However, the use of ABPP in Comparative Example 11 also leaded to the decrease of low-temperature performance to some extent.

The above specific embodiments are used to illustrate the present application, which are only used to help understand the present application, but not to limit it. Further, the singular terms “a”, “an” and “the” include plural reference and vice versa unless the context clearly indicates otherwise. According to the concept of the present application, those skilled in the art may also make some simple deductions, variations or alternatives. These deductions, variations or alternatives also fall within the scope of the claims of the present application.

1. A non-aqueous electrolyte for a lithium ion battery, comprising a non-aqueous organic solvent and a lithium salt, characterized in that the non-aqueous electrolyte further comprises one or more selected from the group consisting of compounds represented by Formula 1 and compounds represented by Formula 2: 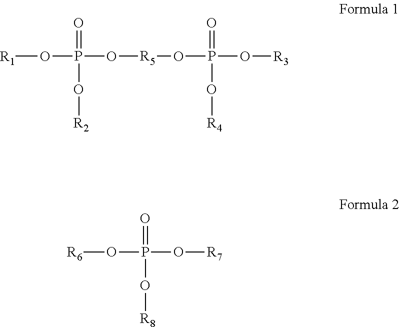
in Formula 1, R₁, R₂, R₃ and R₄ are each independently selected from a substituted or unsubstituted alkyl group of 1-5 carbon atoms, a substituted or unsubstituted ether group of 1-5 carbon atoms and a substituted or unsubstituted unsaturated hydrocarbon group of 2-5 carbon atoms, provided that at least one of R₁, R₂, R₃ and R₄ is the substituted or unsubstituted unsaturated hydrocarbon group of 2-5 carbon atoms, and R₅ is selected from a substituted or unsubstituted alkylene group of 1-5 carbon atoms and a substituted or unsubstituted ether group of 1-5 carbon atoms;
in Formula 2, R₆, R₇ and R₈ are each independently selected from a substituted or unsubstituted alkyl group of 1-5 carbon atoms, a substituted or unsubstituted ether group of 1-5 carbon atoms and a substituted or unsubstituted unsaturated hydrocarbon group of 2-5 carbon atoms, provided that at least one of R₆, R₇ and R₈ is the substituted or unsubstituted unsaturated hydrocarbon group of 2-5 carbon atoms.

2. The non-aqueous electrolyte of claim 1, wherein the alkyl group of 1-5 carbon atoms is selected from methyl, ethyl, n-propyl, isopropyl, n-butyl, isobutyl, sec-butyl, tert-butyl, n-pentyl, isopentyl, sec-pentyl and neopentyl; the unsaturated hydrocarbon group of 2-5 carbon atoms is selected from vinyl, propenyl, allyl, butenyl, pentenyl, methyl vinyl, methyl allyl, ethynyl, propinyl, propargyl, butynyl and pentynyl;
the alkylene group of 1-5 carbon atoms is selected from methylene, ethylidene, n-propylene, isopropylidene, n-butylene, isobutylidene, sec-butylidene, tertiary butyl, pentylene, isoamylidene, sec-pentylene and neopentylidene;
the ether group of 1-5 carbon atoms is selected from a methyl ether, diethyl ether, methyl ethyl ether, propyl ether, methyl propyl ether and ethyl propyl ether;
the “substituted” is that one or more hydrogen elements are substituted by halogen; preferably, the halogen is fluorine.

3. The non-aqueous electrolyte of claim 2, wherein the compounds represented by Formula 1 are following compounds 1-22:

| | |
|---|---|
| 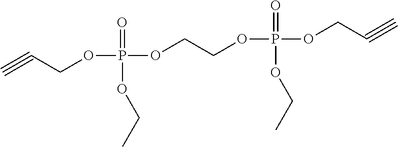 [SMILES: C#CCOP(=O)(OCC)OCCOP(=O)(OCC)OCC#C] | Compound 1 |
| 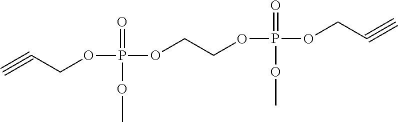 [SMILES: C#CCOP(=O)(OC)OCCOP(=O)(OC)OCC#C] | Compound 2 |
| 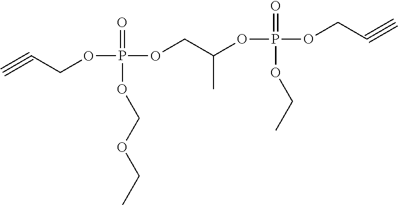 [SMILES: C#CCOP(=O)(OCOCC)OCC(C)OP(=O)(OCC)OCC#C] | Compound 3 |
| 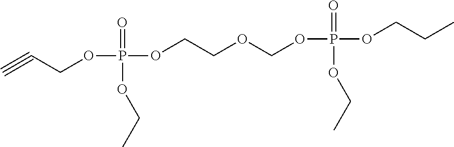 [SMILES: C#CCOP(=O)(OCC)OCCOCOP(=O)(OCC)OCCC] | Compound 4 |
| 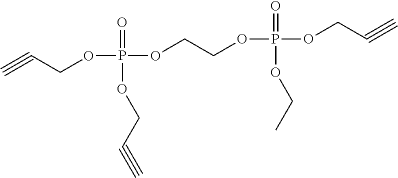 [SMILES: C#CCOP(=O)(OCC)OCCOP(=O)(OCC#C)OCC#C] | Compound 5 |
| 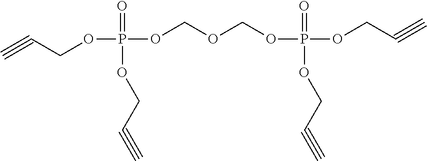 [SMILES: C#CCOP(=O)(OCC#C)OCOCOP(=O)(OCC#C)OCC#C] | Compound 6 |
| 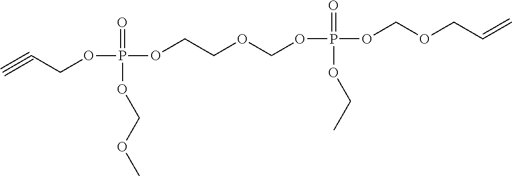 [SMILES: C#CCOP(=O)(OCCOCOP(=O)(OCC)OCOCC=C)OCOC] | Compound 7 |
| 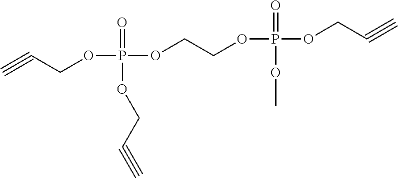 [SMILES: C#CCOP(=O)(OC)OCCOP(=O)(OCC#C)OCC#C] | Compound 8 |
| 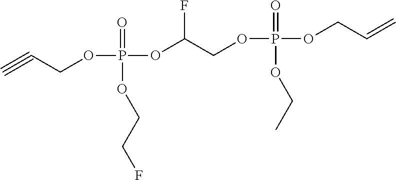 [SMILES: C#CCOP(=O)(OCCF)OC(F)COP(=O)(OCC)OCC=C] | Compound 9 |
| 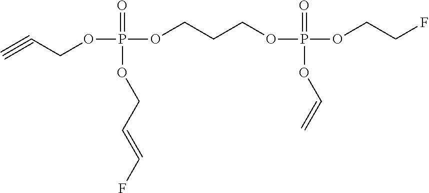 [SMILES: C#CCOP(=O)(OC/C=C/F)OCCCOP(=O)(OC=C)OCCF] | Compound 10 |
| 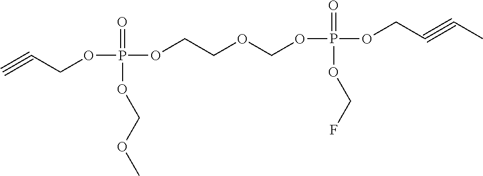 [SMILES: C#CCOP(=O)(OCCOCOP(=O)(OCF)OCC#CC)OCOC] | Compound 11 |
| 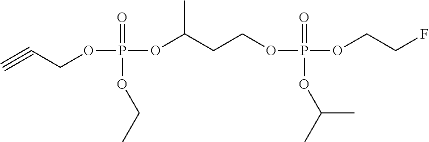 [SMILES: C#CCOP(=O)(OCC)OC(C)CCOP(=O)(OCCF)OC(C)C] | Compound 12 |
| 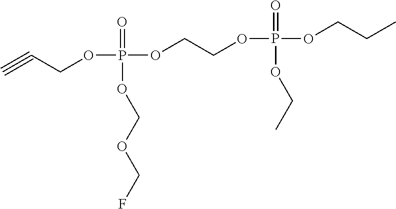 [SMILES: C#CCOP(=O)(OCCOP(=O)(OCC)OCCC)OCOCF] | Compound 13 |
| 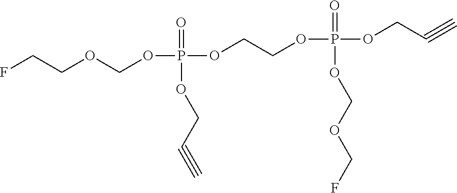 [SMILES: C#CCOP(=O)(OCCOP(=O)(OCC#C)OCOCCF)OCOCF] | Compound 14 |
| 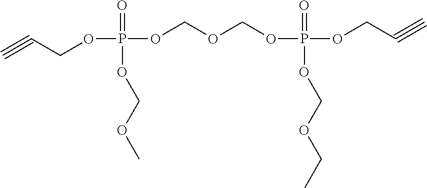 [SMILES: C#CCOP(=O)(OCOC)OCOCOP(=O)(OCC#C)OCOCC] | Compound 15 |
| 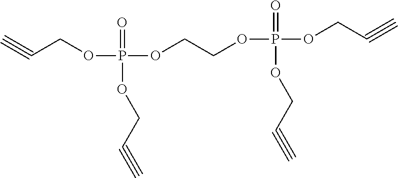 [SMILES: C#CCOP(=O)(OCC#C)OCCOP(=O)(OCC#C)OCC#C] | Compound 16 |
| 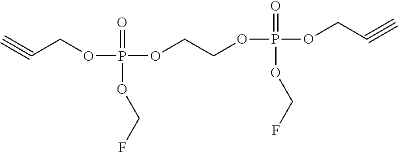 [SMILES: C#CCOP(=O)(OCF)OCCOP(=O)(OCF)OCC#C] | Compound 17 |
| 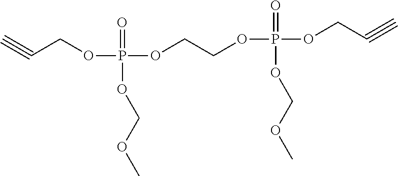 [SMILES: C#CCOP(=O)(OCCOP(=O)(OCC#C)OCOC)OCOC] | Compound 18 |
| 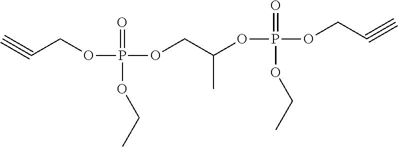 [SMILES: C#CCOP(=O)(OCC)OCC(C)OP(=O)(OCC)OCC#C] | Compound 19 |
| 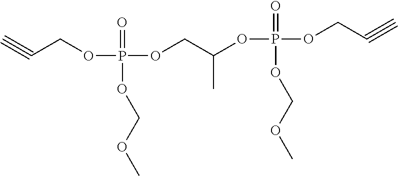 [SMILES: C#CCOP(=O)(OCOC)OCC(C)OP(=O)(OCC#C)OCOC] | Compound 20 |
| 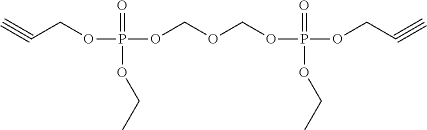 [SMILES: C#CCOP(=O)(OCC)OCOCOP(=O)(OCC)OCC#C] | Compound 21 |
| 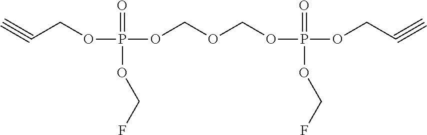 [SMILES: C#CCOP(=O)(OCF)OCOCOP(=O)(OCF)OCC#C] | Compound 22 |

4. The non-aqueous electrolyte of claim 1, wherein the content of the compound represented by Formula 1 is 10 ppm or more relative to the total mass of the non-aqueous electrolyte.

5. The non-aqueous electrolyte of claim 4, wherein the content of the compound represented by Formula 1 is 2% or less relative to the total mass of the non-aqueous electrolyte.

6. The non-aqueous electrolyte of claim 1, wherein the content of the compound represented by Formula 2 is 0.1-2% relative to the total mass of the non-aqueous electrolyte.

7. The non-aqueous electrolyte of claim 1, further comprising at least one of unsaturated cyclic carbonate, fluorinated cyclic carbonate, cyclic sulfonate lactone and cyclic sulfate.

8. The non-aqueous electrolyte of claim 1, wherein the non-aqueous organic solvent is a mixture of cyclic carbonate and chain carbonate.

9. A lithium ion battery, comprising a positive electrode, a negative electrode and a separator interposed between the positive electrode and the negative electrode, characterized in that the lithium ion battery further comprises the non-aqueous electrolyte of claim 1.

10. The lithium ion battery of claim 9, wherein the positive electrode comprises a positive electrode active material selected from at least one of LiNiₓCo_{y}Mn_{z}L_{(1-x-y-z)}O₂, LiCo_{x′}L_{(1-x′)} O₂, LiNi_{x″}L′_{y′}Mn_{(2-x″-y′)}O₄ and Li_{z′}MPO₄, wherein L is at least one of Al, Sr, Mg, Ti, Ca, Zr, Zn, Si or Fe, 0≤x≤1, 0≤y≤1, 0≤z≤1, 0<x+y+z≤1, 0<x′≤1, 0.3≤x″≤0.6, 0.01≤y′≤0.2, L′ is at least one of Co, Al, Sr, Mg, Ti, Ca, Zr, Zn, Si and Fe; 0.5≤z′≤1, M is at least one of Fe, Mn and Co.

11. The non-aqueous electrolyte of claim 2, wherein the compound represented by Formula 2 is at least one of the following compounds 23-28.

| | |
|---|---|
| 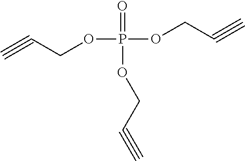 | Compound 23 |
| 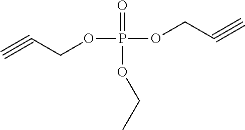 | Compound 24 |
| 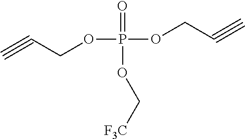 [SMILES: C#CCOP(=O)(OCC#C)OCC(F)(F)F] | Compound 25 |
| 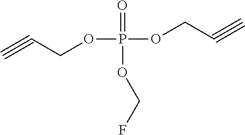 | Compound 26 |
| 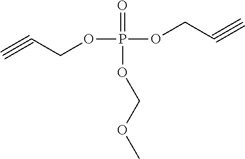 | Compound 27 |
| 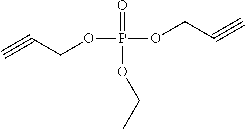 | Compound 28 |

12. The non-aqueous electrolyte of claim 7, wherein based on the total mass of the non-aqueous electrolyte, content of the unsaturated cyclic carbonate is 0.1-5%, content of the fluorinated cyclic carbonate is 0.1-30%, content of the cyclic sulfonate lactone is 0.1-5%, and content of the cyclic sulfate is 0.1-5%.

13. The non-aqueous electrolyte of claim 7, wherein the unsaturated cyclic carbonate is selected from at least one of vinylene carbonate (CAS: 82-36-6), vinylethylene carbonate (CAS: 4427-96-7) and methylene ethylene carbonate (CAS: 124222-05-5), the fluorinated cyclic carbonate is selected from at least one of fluoroethylene carbonate (CAS: 114435-02-8), trifluoromethyl ethylene carbonate (CAS: 167951-80-6) and difluoroethylene carbonate (CAS: 311810-76-1), the cyclic sulfonate lactone is selected from at least one of 1,3-propane suhone (CAS: 1120-71-4), 1,4-butane sultone (CAS: 1633-83-6) and propene 1,3-sultone (CAS: 21806-61-1), and the cyclic sulfate is selected from at least one of ethylene sulfate (CAS: 1072-53-3) and 4-methyl ethylene sulfate (CAS: 5689-83-8).

14. The non-aqueous electrolyte of claim 8, wherein the cyclic carbonate is selected from at least one of ethylene carbonate, propylene carbonate and butylene carbonate, and the chain carbonate is selected from at least one of dimethyl carbonate, diethyl carbonate, methyl ethyl carbonate and methyl propyl carbonate.

15. The non-aqueous electrolyte of claim 8, wherein the lithium salt is selected from at least one of LiPF₆, LiBF₄, LiPO₂F₂, LiTFSI, LiBOB, LiDFOB and LiN(SO₂F)₂.

16. The non-aqueous electrolyte of claim 9, wherein the content of the compound represented by Formula 1 is 10 ppm or more relative to the total mass of the non-aqueous electrolyte.

17. The non-aqueous electrolyte of claim 16, wherein the content of the compound represented by Formula 1 is 2% or less relative to the total mass of the non-aqueous electrolyte.

18. The non-aqueous electrolyte of claim 9, wherein the content of the compound represented by Formula 2 is 0.1-2% relative to the total mass of the non-aqueous electrolyte.

19. The non-aqueous electrolyte of claim 9, wherein the non-aqueous organic solvent is a mixture of cyclic carbonate and chain carbonate;
preferably, the cyclic carbonate is selected from at least one of ethylene carbonate, propylene carbonate and butylene carbonate, and the chain carbonate is selected from at least one of dimethyl carbonate, diethyl carbonate, methyl ethyl carbonate and methyl propyl carbonate.

20. The non-aqueous electrolyte of claim 19, wherein the lithium salt is selected from at least one of LiPF₆, LiBF₄, LiPO₂F₂, LiTFSI, LiBOB, LiDFOB and LiN(SO₂F)₂.
